(19) United States
(12) Patent Application Publication
(10) Pub. No.: US 2004/0088929 A1
(43) Pub. Date: May 13, 2004

(54) Landscaping block

(75) Inventors: William B. Dawson, Medina, MN (US); Robert A. MacDonald, Plymouth, MN (US)

Correspondence Address: POPOVICH, WILES & O'CONNELL, PA, 650 THIRD AVENUE SOUTH, SUITE 600, MINNEAPOLIS, MN, 55402, US

(73) Assignee: Keystone Retaining Wall Systems, Inc.

(21) Appl. No.: 10/668,796

(22) Filed: Sep. 23, 2003

Related U.S. Application Data
(63) Continuation-in-part of application No. 29/185,034, filed on Jun. 20, 2003.
Application No. 29/185,034 is a continuation-in-part of application No. 29/170,809, filed on Nov. 12, 2002, now Pat. No. D479342.

(51) Int. Cl. E04B 1/32; E04G 11/04; E02D 27/00

(52) U.S. Cl. 52/102; 52/245; 52/604

(57) ABSTRACT

Landscaping blocks for decorative edging are designed to form overlapping or interlocking joints between adjacent blocks, so that weed growth between the blocks is prevented or deterred when the blocks are arranged as a border or edging.

This application is a continuation-in-part of application Ser. No. 29/185,034, filed Jun. 20, 2003, which is continuation-in-part of application Ser. No. 29/170,809, filed Nov. 12, 2002, now U.S. Pat. No. D479,342, the contents of which are hereby incorporated herein by reference.

### FIELD OF THE INVENTION

This invention relates to landscaping blocks for decorative edging. In particular, this invention relates to landscaping blocks having a natural stone appearance which, when used in rows, prohibit weed growth between the blocks.

### BACKGROUND OF THE INVENTION

Numerous methods and materials exist for the construction of borders, curbs or edging for landscaping or site improvement work. Such borders, edges or curbs serve several functions. First, they are decorative, and provide an orderly transition from a garden area to a lawn, or from a lawn to a sidewalk, etc. Second, they serve to separate different areas with different forms of plant life or other landscaping elements, thereby reducing maintenance requirements such as removing weeds, or trimming back plant life that would otherwise spread. Third, they can ease the process of lawn mowing by eliminating the need to hand trim the border areas of the lawn after mowing the main areas with a mechanical lawn mower.

One method of providing an edging is the use of numerous natural stones or man-made bricks or blocks. Such stones or bricks are installed by digging a shallow trench and placing the stones or bricks more or less continuously along the length of the trench. Such materials may also simply be placed on top of the ground without digging a trench. Natural stone has long been used for this application, but has irregular shapes and requires labor-intensive fitting of the stones along a border. Bricks or rectangular blocks may also be used for lawn edging but do not lend themselves to the construction of curvilinear edgings, which are found in most landscaping applications. These blocks must be shaped and cut to avoid gaps that may allow penetration or growth of plant life within these gaps. Plant life growing between the blocks disrupts the clean, smooth appearance of such edges or borders and may often be undesirable adventitious plant growth such as weeds or the like.

It would be desirable to have a landscaping block that has a natural stone appearance, could be shaped into straight or curvilinear borders and edges, and would avoid or deter unwanted plant growth between blocks.

### SUMMARY OF THE INVENTION

The present invention provides a landscaping block that can be arranged with other blocks of the invention to provide overlapping or interlocking joints between adjacent blocks, deterring or preventing vegetation growth through these joints and between the blocks. One aspect of the present invention is a landscaping block having a top surface and a generally opposed bottom surface, first and second opposed sides, with each side extending from the top surface to the bottom surface. The block has opposed first and second ends, with each end extending from the top surface to the bottom surface and from the first side to the second side. The first end of the block is wider than the second end at the top surface and is wider than the second at the bottom surface, so that the first end is larger in area than the second end. The first side of the block includes a first upper face extending from the top to a first ledge, and the first ledge extends to a first lower face. The first ledge may extend outward or inward from the first side. The second side of the block may have a second upper face extending from the top to a second ledge, with the second ledge extending to a second lower face. The second ledge may extend outward or inward from the first side. Alternatively, according to another embodiment, the first ledge of the block may extend inward from the first side and the second ledge may extend outward from the second side. When the first side of any of the blocks of this invention is placed adjacent the second side of another block, the first and second ledges form an interlocking or overlapping joint that prevents or deters growth of vegetation around the joint between the blocks.

Another aspect of the invention is a landscaping block system with multiple blocks. Each block of the system has a top surface and a generally opposed bottom surface, and first and second generally opposed sides, with each side extending from the top to the bottom. Each block of the system has opposed first and second ends, with each end extending from the top to the bottom and from the first side to the second side, and the first end is larger in surface area than the second end. The first side includes a first upper face extending from the top to a first ledge, with the first ledge extending to a first lower face. The second side includes a second upper face extending from the top to a second ledge, with the second ledge extending to a second lower face. The blocks of the inventive system are positioned so that when the first side of one block is placed adjacent either the first or second side of another block, the first and second ledges form an overlapping or interlocking relationship. The first ledge of the block may extend outward from the first side and the second ledge may extend outward from the second side. In an alternate embodiment, the first ledge of a block may extend outward or inward from the first side. In another embodiment, the first ledge of a block may extend inward from the first side and the second ledge may extend outward from the second side.

Another embodiment of the present invention is a method of installing a landscaping block system. According to this method, multiple landscaping blocks are provided, with each block having a top surface and an opposed bottom surface, opposed first and second ends and first and second opposed sides. Each end of a block extends from the top surface to the bottom surface and from the first side to the second side, and the first end is larger in surface area than the second end. Each side extends from the top to the bottom. The first side includes a first upper face extending from the top to a first ledge, with the first ledge extending to a first lower face. The second side includes a second upper face extending from the top to a second ledge, with the second ledge extending to a second lower face. The inventive method involves placing one of the blocks adjacent another of the blocks, so that either of the first and second ledges on the adjacent blocks forms an overlapping or interlocking relationship. The method may further involve placing a first block with its bottom surface facing down adjacent a second block with its top surface facing down. An alternative block for use in this inventive method may be formed the first ledge of the block extending outward from the first side and the second ledge of the block extending outward from the second side. Other blocks for use in this method may be formed with the first ledge of the block extending outward or inward from the first side.

Another embodiment of this invention is a landscaping block having a top surface and an opposed bottom surface, first and second opposed sides, with each side extending from the top surface to the bottom surface, and opposed first and second ends. Each end extends from the top surface to the bottom surface and from the first side to the second side. The first end is larger in area than the second end. The first side includes a first upper face extending from the top to a first ledge, with the first ledge extending to a first lower face. This landscape block is designed and adapted so that, by placing one landscaping block adjacent another landscaping block, either of the first and second ledges on the adjacent blocks forms an interlocking relationship between the blocks.

### BRIEF DESCRIPTION OF THE DRAWINGS

FIG. 1A is a perspective view of an embodiment of a landscaping block according to this invention and FIG. 1B is a top plan view of the block of FIG. 1A.

FIG. 2A is a perspective view of another embodiment of a landscaping block according to this invention and FIG. 2B is a top plan view of the block of FIG. 2A.

FIG. 3 is a bottom plan view of the block of FIG. 2A.

FIG. 4 is a front plan view of the block of FIG. 2A.

FIG. 5 is a side elevational view of the block of FIG. 2A.

FIG. 6 is a perspective view of a row constructed with the landscaping block of shown in FIGS. 2A, 2B and 3-5.

FIG. 7 is a perspective view of a circle constructed with the landscaping block shown in FIGS. 2A, 2B and 3-5.

FIG. 8 is a perspective view of a partial straight row constructed with the landscaping block shown in FIGS. 2A, 2B and 3-5.

FIGS. 9A to 9C illustrate perspective, top, and bottom views, respectively, of an alternate embodiment of a landscaping block of this invention.

FIG. 10 is a perspective view of a row constructed with the landscaping block of FIGS. 9A-9C.

FIG. 11 is a top view of demolded block pairs of this invention.

### DETAILED DESCRIPTION OF THE PREFERRED EMBODIMENTS

In this application, “upper” and “lower” and “top” and “bottom” refer to the major surfaces of the block when it is placed in a course of blocks, thus forming a landscaping border. “Front” and “back” refer to opposed ends of the block. These actually are arbitrary designations for convenience in discussion and description, and it is to be understood that the block can be used in various orientations.

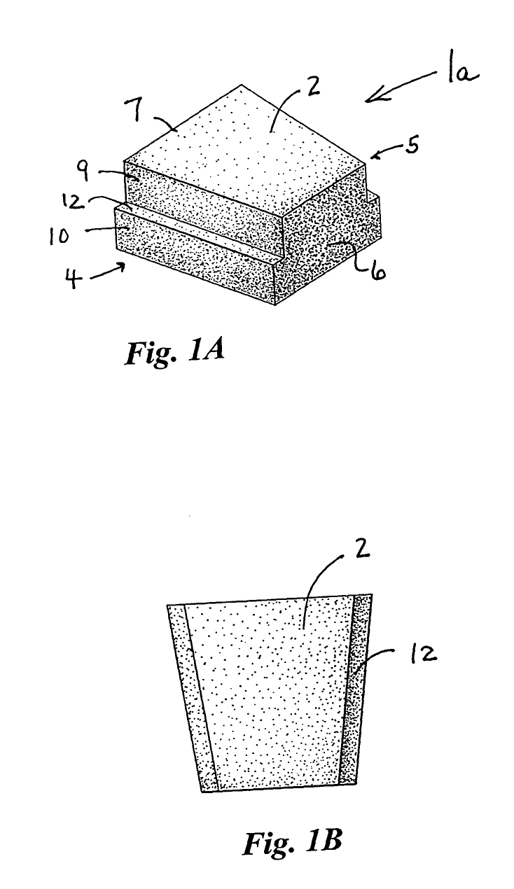

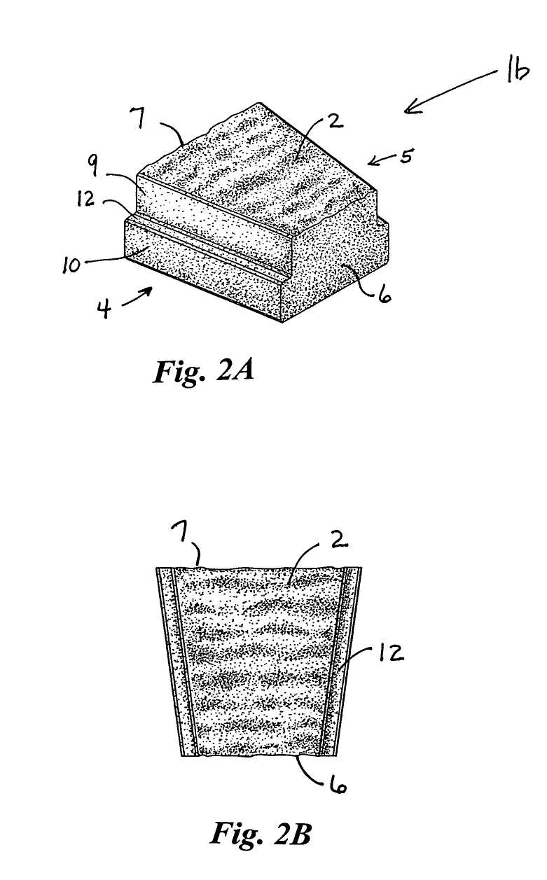

Embodiments of the landscaping blocks of this invention may be used in variously shaped rows and configurations to form borders and edges. The major opposing surfaces of the block may be smooth in appearance, such as that shown for block 1a in FIGS. 1A and 1B, or these surface may have a natural stone appearance such as shown for block 1b in FIGS. 2 through 8. Alternatively, it may be convenient to manufacture the block such that one major surface is smooth, and one is rough, that is, more similar to the appearance of natural stone. Regardless of their surface appearance, either major surface can be used as either the top or the bottom of the block. The design of the block permits the formation of a lap joint between two adjacent blocks. The lap joint provides a labyrinth that prevents or deters the penetration of light down between the blocks and prevents or deters plants from growing up between the blocks. The blocks have a low profile and are wide enough that, when arranged in borders or edges, lawn mowers can ride on them, thus resulting in low maintenance borders and elimination of the need for hand trimming.

An embodiment of a landscaping block of this invention now is described with reference to the Figures. FIGS. 1A and 1B and FIGS. 2A and 2B illustrate landscaping blocks 1a and 1b, respectively of the present invention. The block may be made of a rugged, weather-resistant material, preferably pre-cast concrete or any material appropriate to the conditions under which it is to be used. Other suitable materials include plastic, reinforced fibers, wood, metal, stone and the like.

Because only the surface appearance of block 1a differs from that of block 1b, the numbering of the elements of these blocks will be the same throughout this description and the block may be referred to in a generic way as block 1. Block 1a in FIGS. 1A and 1B and block 1b in FIGS. 2 to 8 have top or first major surface 2, opposed bottom or second major surface 3, and first and second opposed sides 4 and 5. Each side 4 and 5 extends from top 2 to bottom 3. First and second opposed ends (i.e., the front and back) 6 and 7 extend from top 2 to bottom 3 and from first side 4 to opposed side 5. Sides 4 and 5 have an upper face 9 and lower face 10 (shown in side view in FIG. 5). Upper face 9 extends from top 2 to ledge 12. Face 9 is generally planar but may have beveled or rounded edges.

The distance between first and second ends 6 and 7 defines a block 1 length, and the distance between opposed top 2 and bottom 3 major surfaces defines a thickness. The thickness of the block 1 is generally constant. The distance between first 4 and second 5 opposed sides defines a width; the width of the first end 6 is greater than the width of the second end 7 as measured at the edges of the first 6 and second 7 ends at the top surface 2, and the width of the first end 6 is greater than the width of the second end 7 as measured at the edges of the first 6 and second 7 ends at the bottom surface 3. Thus, the first end 6 has a greater area than the second end 7.

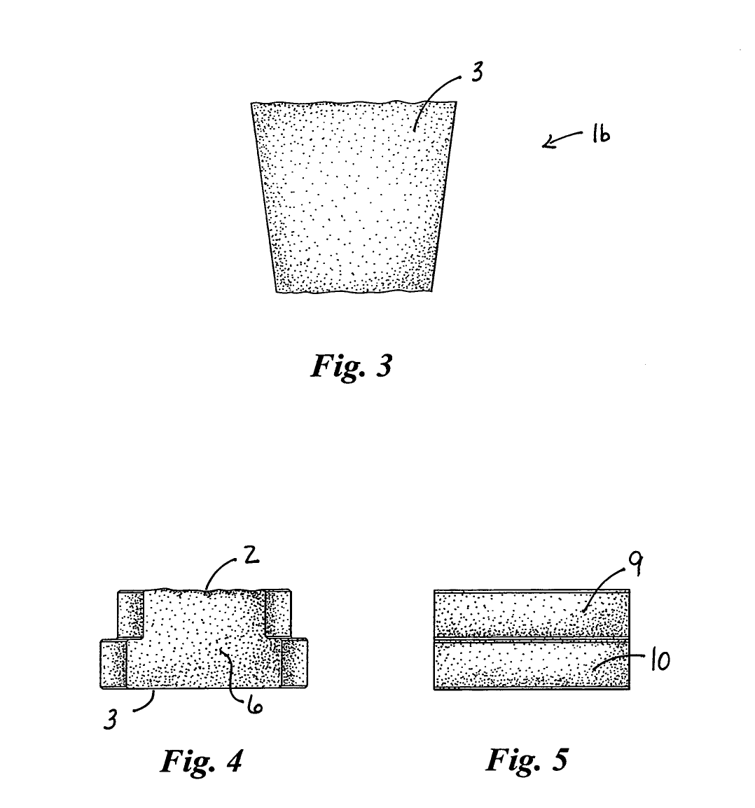

While FIGS. 1A and 2A show block 1a in perspective view, FIGS. 1B and 2B show a top view. FIG. 3 shows the bottom view of block 1b. These figures illustrate that the block 1 has angled side surfaces, so that the front or first end 6 of the block 1 is smaller in width and surface area than the back or second end 7 of the block 1. This is also shown in an end view in FIG. 4, which shows that second end 7 is larger in surface area than first end 6.

Opposed major surfaces 2 and 3 may be textured to resemble natural stone. This texturing can be done by any method known to one of skill in the art, and includes tumbling blocks together, forming the blocks in molds in pairs and splitting the blocks apart and mechanical texturing. A suitable mechanical texturing method is described in commonly assigned, co-pending application U.S. Ser. No. 10/150,484 (Suto et al.), filed May 17, 2002, incorporated herein by reference in its entirety. The texturing methods may result in texturing some or all of the surfaces of the block. For example, a desirable and natural appearance for the block is one in which there are rounded side edges. Although the exposed block surfaces are designed herein as being textured, there will be some applications in which a smooth surface is desired. Thus, blocks having a smooth surface fall within the scope of the present invention.

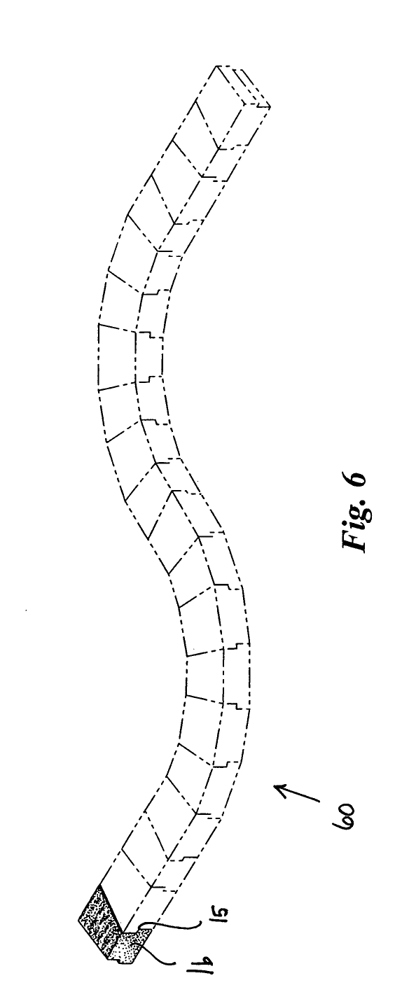

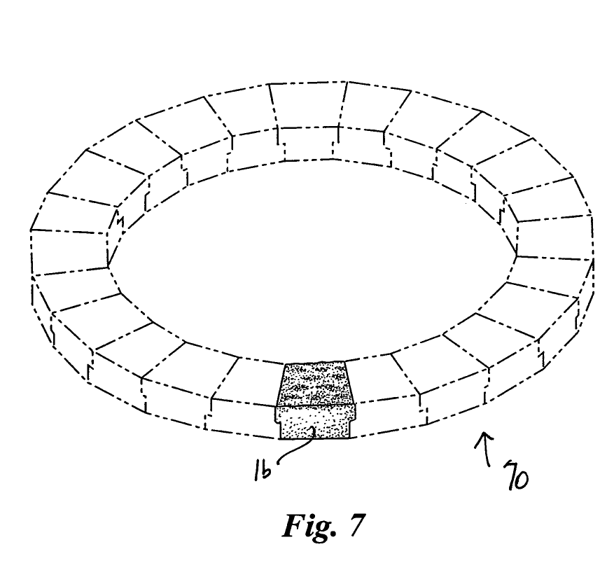

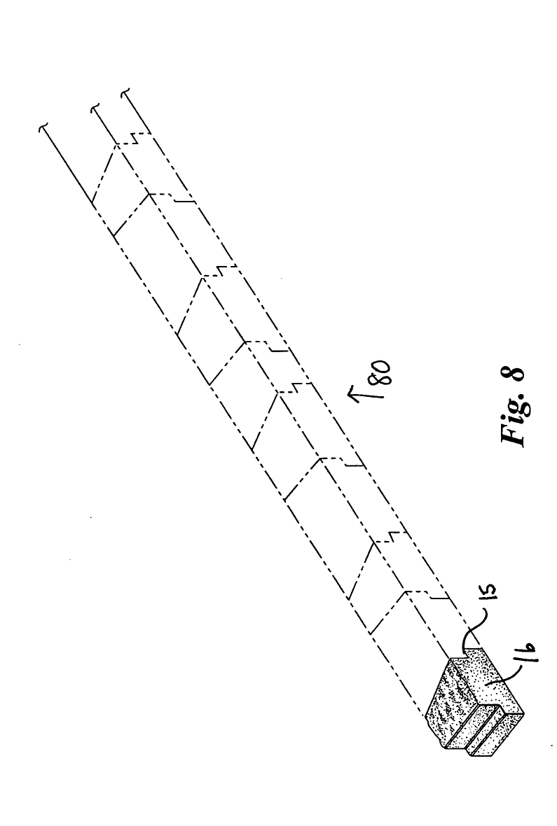

Ledge 12 provides a way to interlock adjacent blocks 1 together, but also is advantageous because the overlap or interlock of ledges 12 on adjacent blocks 1 provides a labyrinth that minimizes the possibility of vegetation growing up through any spaces between two adjacent blocks 1. Sunlight is prevented from passing between the blocks to earth below the blocks 1. The ledges 12 of adjacent blocks 1 meet to form lap joint 15, as illustrated in curvilinear row 60 of blocks shown in FIG. 6, circle 70 of blocks in FIG. 7, and partial straight row 80 in FIG. 8. To form a circular border, the blocks 1 are placed all in the same orientation. For straight sections 80 of a border, such as shown in FIG. 8, the orientation of adjacent blocks 1 is alternated so that the angles of the blocks are complementary. For straight sections 80 and curvilinear rows 60, the orientation of adjacent blocks 1 is alternated so that alternatively either the top 2 or bottom 3 surface will form the exterior of the completed section. Accordingly, when the blocks 1 or any blocks of this invention (such as block 20, described further below) are to be alternated, it is preferable for the ledge 12 to be located at about the mid-point of the height of the each of the first and second opposed sides 4 and 5. Thus, when the blocks are shaped in this fashion, they form an essentially even exterior, allowing the wheels of a lawn mower to firmly and smoothly ride thereon. The angled shape of the blocks permits the construction of a curvilinear row or a circle without any gap between adjacent blocks. This is very desirable both for the appearance of a border and for the prevention of the growth of plants through a space between adjacent blocks.

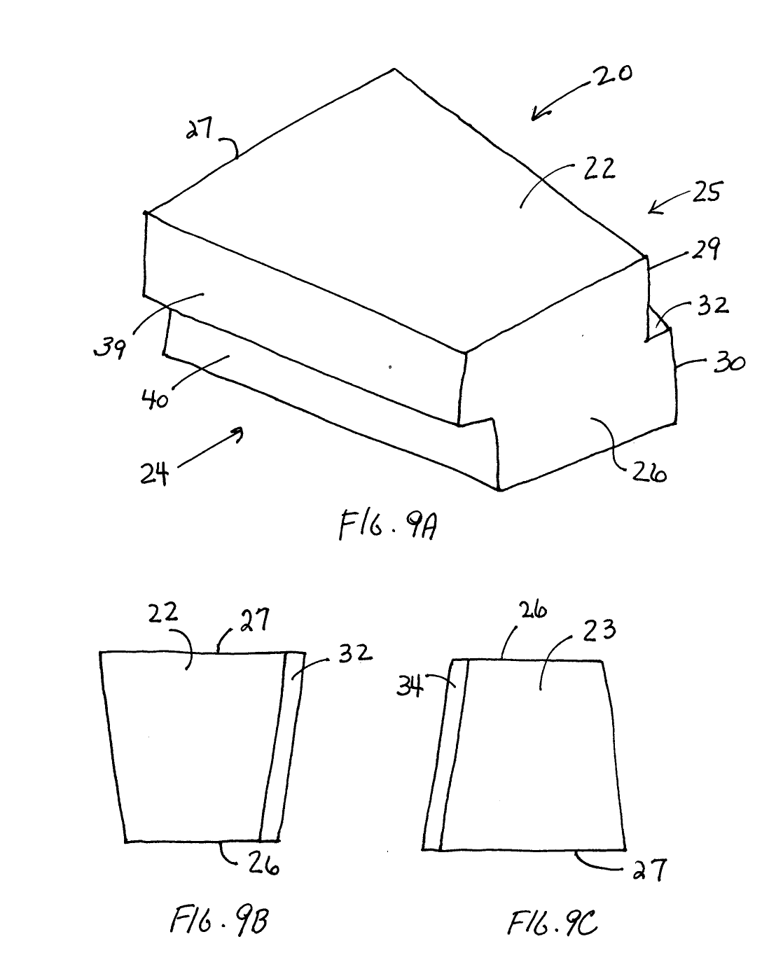

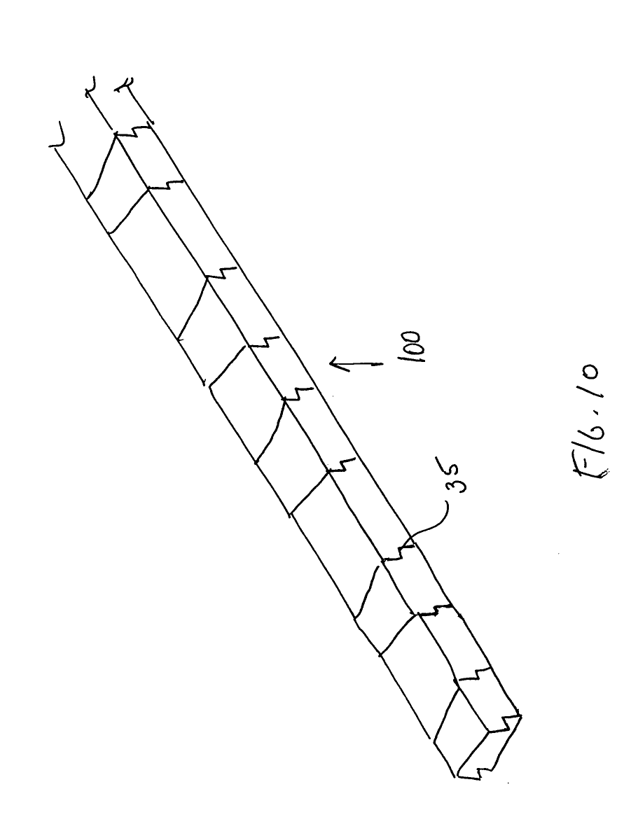

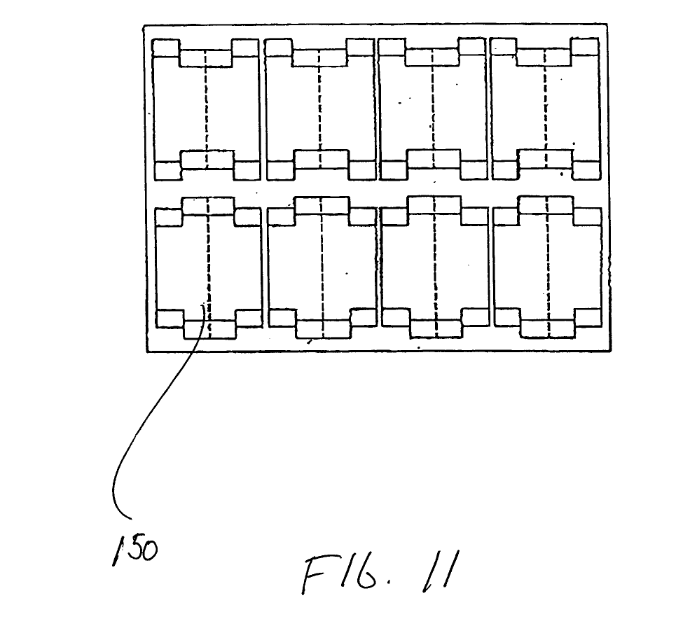

FIGS. 9A to 9C and 10 illustrate another embodiment of the block of this invention. Block 20 has the overall tapered or angled shape similar to that of block 1 in FIGS. 1 to 8. Block 20 has top or major surface 22, generally opposed bottom or major surface 23, and first and second opposed sides 24 and 25. Each side extends from top 22 to bottom 23. First and second opposed ends (i.e., the front and back) 26 and 27 extend from top 22 to bottom 23 and from first side 24 to opposed side 25. Side 24 has upper face 39 and lower face 40 and side 25 has upper face 29 and lower face 30. Upper face 39 extends from top 22 to ledge 34 and lower face 40 extends from ledge 34 to bottom 23. Upper face 29 extends from top 22 to ledge 32, and lower face 30 extends from the ledge to bottom surface 23. Face 29 is generally planar but may have beveled or rounded edges. The depth of the ledge 34 is sufficient to form an interlocking relationship when blocks 20 are placed next to one another in a row, and the overlap of these ledges 34 is sufficient to prevent vegetation from growing up between blocks 20 in a row. This is at least in part because light is prevented from reaching the ground beneath the blocks 20.

Row 100 in FIG. 10 illustrates lap joints 35 between adjacent blocks, formed when the ledge on one side of a block meets the ledge on the side of an adjacent block.

Changing the orientation of the blocks as they are set down may form any desirable shape for a course of the landscaping blocks. For example, curvilinear row or course of blocks orienting the blocks as desired to form the desirable curve as shown in FIG. 6 may form 60 (formed from block 1). A circular course of blocks 70, shown in FIG. 7, can be formed by reversing tops and bottoms of adjacent blocks; and having the narrower or back surface facing the inside of the circle. A straight course or row 80 can be formed by positioning a first block top up, flipping the next block over front to back and placing it top down, as illustrated in FIGS. 8 and 10.

These blocks may have any desired dimension. Typically, however, these blocks may range from about 2.37 to about 3 inches (6 to 7.6 cm) thick and about 6 inches (15.2 cm) long (i.e., the distance from the front to the back surface). The first and second ends of the block typically are about 8 inches (20.3 cm) and 6 inches (15.2 cm) wide, respectively. For blocks of this dimension, the ledge is about 0.625 inches (1.6 cm) wide.

When these blocks are manufactured, they are formed as mirror image pairs joined at the major surfaces (e.g., top and bottom 2 and 3 of block 1) and are then subsequently split using a block splitter, as known in the art, to provide a rough appearance to the surfaces. FIG. 11 illustrates block pairs 150 on a pallet after they are formed and before they are split. FIG. 11 shows eight units, or pairs of blocks, having exited a mold. These blocks are then split to form two blocks (e.g., block 1 as in FIG. 1) such that four of the pairs are split to form top surfaces 2 and the other four pairs are split to form bottom surfaces 3.

Other methods may be utilized to form a variety of surface appearances. The blocks may be further tumbled or treated to provide texture to all surfaces. Such methods are well known in the art. Also, it should be noted that these blocks are manufactured on their sides with the narrowest part of the block at the top of the mold. This orientation facilitates removal of the block or blocks from the mold.

Although particular embodiments have been disclosed herein in detail, this has been done for purposes of illustration only, and is not intended to be limiting with respect to the scope of the appended claims, which follow. In particular, it is contemplated by the inventor that various substitutions, alterations, and modifications may be made to the invention without departing from the spirit and scope of the invention as defined by the claims. For instance, the choice of materials or variations in the shape or angles at which some of the surfaces intersect are believed to be a matter of routine for a person of ordinary skill in the art with knowledge of the embodiments disclosed herein.

What is claimed is:

1. A landscaping block, comprising:
a top surface and an opposed bottom surface;
first and second opposed sides, each side extending from the top surface to the bottom surface;
opposed first and second ends, each end extending from the top surface to the bottom surface and from the first side to the second side, the first end being wider than the second end at a surface selected from the top and bottom surfaces, the first end being larger in area than the second end; and
the first side including a first upper face extending from the top to a first ledge, the first ledge extending to a first lower face.

2. The landscaping block of claim 1 wherein the first ledge extends outward from the first side.

3. The landscaping block of claim 1 wherein the first ledge extends inward from the first side.

4. The landscaping block of claim 1 wherein the second side comprises a second upper face extending from the top to a second ledge, the second ledge extending to a second lower face.

5. The landscaping block of claim 4 wherein the second ledge extends outward from the second side.

6. The landscaping block of claim 4 wherein the second ledge extends inward from the second side.

7. The landscaping block of claim 1 wherein the first ledge extends inward from the first side and the second ledge extends outward from the second side.

8. The landscaping block of claim 4 wherein, when the first side of the landscaping block is placed adjacent the second side of another landscaping block, the first and second ledges form an interlocking relationship.

9. A landscaping block system comprising multiple blocks, each block having:
a top surface and an opposed bottom surface;
first and second generally opposed sides, each side extending from the top to the bottom;
opposed first and second ends, each end extending from the top to the bottom and from the first side to the second side, the first end being larger in surface area than the second end;
the first side including a first upper face extending from the top to a first ledge, the first ledge extending to a first lower face;
the second side including a second upper face extending from the top to a second ledge, the second ledge extending to a second lower face;
the blocks being positioned such that when the first side of the landscaping block is placed adjacent either the first or second side of another of the landscaping blocks, the first and second ledges form an interlocking relationship.

10. The landscaping block system of claim 9 wherein the first ledge extends outward from the first side and the second ledge extends outward from the second side.

11. The landscaping block system of claim 9 wherein the first ledge extends outward from the first side.

12. The landscaping block system of claim 9 wherein the first ledge extends inward from the first side.

13. The landscaping block system of claim 9 wherein the first ledge extends inward from the first side and the second ledge extends outward from the second side.

14. A method of installing a landscaping block system, comprising:
providing multiple landscaping blocks, each block having a top surface and an opposed bottom surface; opposed first and second ends; first and second opposed sides; each end extending from the top surface to the bottom surface and from the first side to the second side, the first end being larger in surface area than the second end; each side extending from the top to the bottom; the first side including a first upper face extending from the top to a first ledge, the first ledge extending to a first lower face; the second side including a second upper face extending from the top to a second ledge, the second ledge extending to a second lower face;
placing one of the multiple of landscaping blocks adjacent another of the multiple of landscaping blocks such that either of the first and second ledges on the adjacent blocks forms an interlocking relationship.

15. The method of installing a landscaping block system of claim 14 further comprising placing a first block of the multiple of landscaping blocks with its bottom surface facing down adjacent a second block of the multiple of landscaping blocks with its top surface facing down.

16. The method of claim 14 wherein, in the step of providing multiple landscaping blocks, the first ledge of the block extends outward from the first side and the second ledge of the block extends outward from the second side.

17. The method of claim 14 wherein, in the step of providing multiple landscaping blocks, the first ledge of the block extends outward from the first side.

18. The method of claim 14 wherein, in the step of providing multiple landscaping blocks, the first ledge of the block extends inward from the first side.

19. A landscaping block, comprising:
a top surface and an opposed bottom surface;
first and second opposed sides, each side extending from the top surface to the bottom surface;
opposed first and second ends, each end extending from the top surface to the bottom surface and from the first side to the second side, the first end being larger in surface area than the second end; and
the first side including a first upper face extending from the top to a first ledge, the first ledge extending to a first lower face;
so that, by placing one landscaping block adjacent another landscaping block, either of the first and second ledges on the adjacent blocks forms an interlocking relationship.
